(19) United States
(12) Patent Application Publication
(10) Pub. No.: US 2010/0252341 A1
(43) Pub. Date: Oct. 7, 2010

(54) ELECTRIC ROTARY MACHINE

(76) Inventors: Kohin SHU, Hitachi (JP); Taizo Miyazaki, Hitachi (JP); Akiyoshi Komura, Hitachi (JP); Noriaki Hino, Mito (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/714,715

(22) Filed: Mar. 1, 2010

(30) Foreign Application Priority Data
Apr. 2, 2009 (JP) 2009-089670

(51) Int. Cl. B60K 6/20; H02K 1/12

(52) U.S. Cl. 180/65.21; 310/216.004

(57) ABSTRACT

The electric rotary machine comprises a stator and a rotor. The rotor is incorporated rotatablly inside the stator keeping an air gap between the rotor and the stator, the rotor being divided into at least two of a first rotor and a second rotor in a direction of a rotating shaft thereof, and each of the first and second rotors having field magnets with different polarities disposed alternatively in a rotating direction of the rotor. A magnetic flux control mechanism controls effective magnetic fluxes by varying positions of the field magnets of the second rotor relatively with respect to that of the first rotor in at least the rotating direction of the rotor. The stator core is provided with a magnetoresistive layer that is interposed in the path of the effective magnetic fluxes in the stator core.

### CLAIM OF PRIORITY

The present application claims priority from Japanese patent application serial no. 2009-089670 filed on Apr. 2, 2009, the contents of which are hereby incorporated by reference into this application.

### FIELD OF THE INVENTION

The present invention relates to an electric rotary machine capable of controlling mechanically an amount of effective magnetic fluxes thereof.

### BACKGROUND OF THE INVENTION

In place of conventional induction motors (IM motor), permanent magnet synchronous motors (PM motor) are becoming used popularly, because the efficiency thereof is excellent, and both size and the noise thereof are expected to be reduced. The PM motors are becoming utilized as driving motors, for example, for electric home appliances, rolling stocks and electric cars. Since in an IM motor, the magnetic fluxes themselves have to be generated by exciting current from the motor, there is a problem that a loss is caused due to the flowing of the exciting current. On the other hand, a PM motor is a motor that is provided with permanent magnets on the rotor and outputs torque by making use of the magnetic fluxes of the permanent magnets. For this reason, a PM motor is not required to flow the exciting current and is free from the problem inherent to an IM motor.

However, in the PM motor, a voltage is induced in the armature coils by means of the permanent magnets in proportion to the revolution number thereof. In an application for rolling stocks, cars and the like having a broad range of revolution number, it is necessary that an inverter that drives and controls the PM motor is not broken by an over voltage induced at the time of maximum revolution number thereof. When the PM motor having such characteristic performing a constant output operation while keeping the power source voltage constant, as a measure of broadening the operational velocity while further raising the above referred to maximum revolution number, there is a so called magnetic field weakening control in which a current is caused to flow in the armature coils for canceling out the magnetic fluxes by the permanent magnets so as to equivalently reduce the induced voltage. However, this magnetic field weakening control led to reduction of efficiency of the motor, because the current that never contributes to torque generation has to be flown.

In addition, since it is necessary to flow a large current in the armature coils, as a matter of course, the heat generated in the coils increases. For this reason, the efficiency as an electric rotary machine is reduced in the high revolution number region, and there was a possibility that such as demagnetization of the permanent magnets can be caused due to heating that exceeds the cooler capacity.

Therefore, in place of the electrical magnetic field weakening control, as an electric rotary machine in which an amount of effective magnetic fluxes can be varied mechanically, an electric rotary machine as disclosed, for example, in patent document 1 (JP-A-2001-69609) is known.

The electric rotary machine as disclosed in patent document 1 includes a rotor that is divided into two in the direction of the rotary shaft. Each of the two divided rotor has field magnets with different polarities arranged alternatively in the rotating direction thereof. Further, when operating the electric rotary machine as a motor, respective magnetic pole centers of the field magnets of the two divided rotors are aligned by balancing the magnetic action force between the field magnets of one of the two divided rotors and the field magnets of the other of the two divided rotors with the torque direction of the rotor. When operating the electric rotary machine as a generator, the respective magnetic pole centers of field magnets of the two divided rotors are offset in association with the reversal of the torque direction of the rotor. By varying the respective magnetic pole centers of the two divided rotors in the above manner, the amount of effective magnetic fluxes can be varied mechanically.

Further, among the electric rotary machines using such mechanical variable mechanism, patent document 2 (JP-A-2005-253265) discloses an electric rotary machine in which in order to enhance reliability for a body to be mounted, for example, for a car, for example, a mechanism is provided which can relax impact caused such as to one of the two divided rotors and to the mechanical variable mechanism when the one of the two divided rotors is varied in association with variation of the torque direction of the rotor.

### SUMMARY OF THE INVENTION

In the above mentioned electric rotary machines, there is a problem that, under a condition of mechanical field weakening control during a high speed revolution, an eddy current is caused because of magnetic flux flow in the direction of rotating shaft, and an iron loss of the electric rotary machines increases.

The present invention is to provide an electric rotary machine that permits to greatly decrease the iron loss of the electric rotary machine at the time when rotating in high speed.

The present invention is basically configured as follows. An electric rotary machine comprises:

a stator having a stator core and windings,

a rotor that is incorporated rotatablly inside the stator keeping an air gap between the rotor and the stator, the rotor being divided into at least two of a first rotor and a second rotor in a direction of a rotating shaft thereof, and each of the first and second rotors having field magnets with different polarities disposed alternatively in a rotating direction of the rotor, and

a magnetic flux control mechanism that controls effective magnetic fluxes by varying positions of the field magnets of the second rotor relatively with respect to that of the first rotor in at least the rotating direction of the rotor,

wherein the stator core is provided with a magnetoresistive layer that is interposed in the path of the effective magnetic fluxes in the stator core.

For example, the stator core is divided into at least two in the direction of the rotating shaft, and the magnetoresistive layer has a doughnut shape, and the magnetoresistive layer is interposed between the divided stator cores.

According to the present invention, an electric rotary machine can be provided that permits to greatly decrease iron loss of the electric rotary machine at the time when rotating in high speed.

### BRIEF DESCRIPTION OF THE DRAWINGS

FIGS. 1A and 1B are views for explaining a magnetic flux flow within a stator in an electric rotary machine of a comparative example to the present invention.

FIG. 2 is a view showing an embodiment of an electric rotary machine according to the present invention.

FIGS. 3A and 3B are views showing another embodiment of an electric rotary machine according to the present invention.

FIG. 4 is a diagram showing an exemplary constitution of a driving device for a car on which an electric rotary machine according to the present invention is mounted.

FIG. 5 is a diagram showing another exemplary constitution of a driving device for a car on which an electric rotary machine according to the present invention is mounted.

### DETAILED DESCRIPTION OF EMBODIMENTS

Embodiments for carrying out the present invention will be explained with reference to the drawings as follows.

### Comparative Example

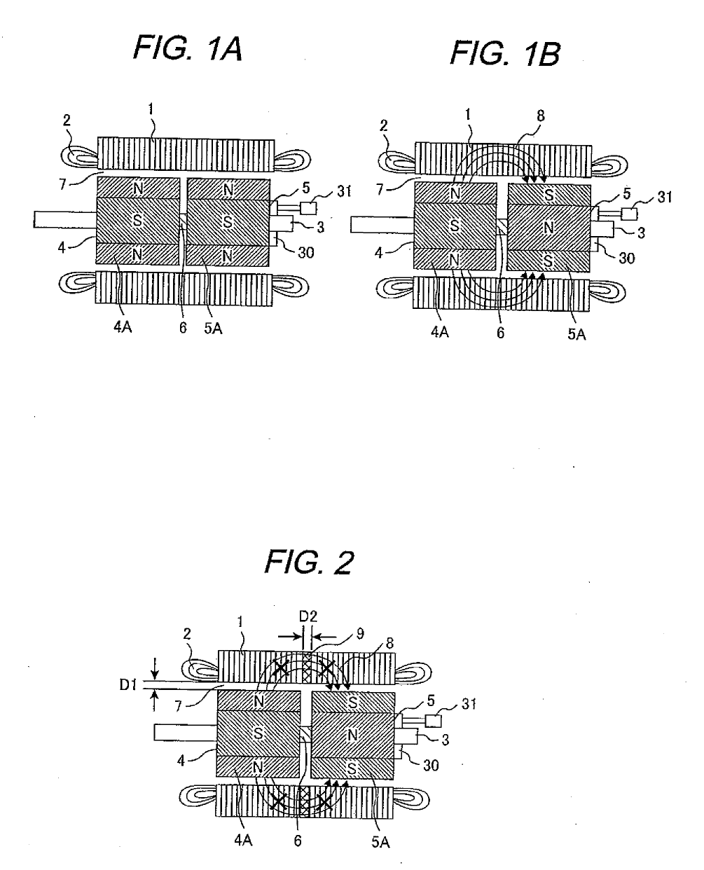

A comparative example and the present embodiment will be explained referring to FIGS. 1 and 2.

FIGS. 1A and 1B are views for explaining magnetic flux flow within a stator in an electric rotary machine according to the comparative example. The electric rotary machine of the comparative example is one capable of controlling mechanically an amount of effective magnetic fluxes by the following structure. As shown in FIG. 1, an inside portion of a cylindrical stator core 1 is provided with a plurality of slots (not shown Figs.) which extend in a rotating shaft direction of the stator core and are disposed in a circumferential direction of the stator core. Armature windings (also called as stator windings or primary windings) 2 are inserted in the respective slots. A housing (not shown) is fitted on an outer periphery of the stator core 1 by means of such as shrink fitting and press fitting. Both ends of the housing in the rotating shaft direction are covered by respective brackets (not shown). A Rotor (Rotors 4 and 5) is incorporated rotatably inside the stator cored keeping an air gap 7 between the rotor 5 and the stator core 1.

The rotor is constituted by a first rotor 4 and a second rotor 5 divided into two in the rotating shaft direction. The first rotor 4 is fixed on a shaft 3 (also called as rotating shaft). The second rotor 5 has a female thread (not shown in Figs.) on an inner surface thereof and is installed on the shaft 3 by engaging the female thread with a helical spline 6 provided on the shaft 3. Thereby, the second rotor 5 is capable of moving on the shaft 3 in the rotating shaft direction while rotating on the shaft 3. The first rotor 4 is provided with a plurality of permanent magnets 4A as a field magnet which are buried in the rotor in such a manner that polarities thereof are alternated in the rotating direction. Further, the second rotor 5 is provided with a plurality of permanent magnets 5A as a field magnet which are also buried in the rotor in such a manner that the polarities thereof are alternated in the rotating direction. Both end side portions of the shaft 3 are supported by bearing devices (not shown) such that the shaft 3 is rotatable. A supporting mechanism of the rotating shaft 3 is constituted by the bearing device, and a supporting mechanism of the second rotor 5 in an axial direction is constituted by a stopper 30 and an actuator 31. The stopper 30 is to limit a movement of the second rotor 5 which is actuated in the axial direction (rotating shaft direction) with the actuator 31 as a servo device. When the electrical rotary machine is driven as a motor or a generator, the second rotor 5 moves in a direction opposite to the first rotor 4 on the helical spline 6 up to a predetermined position where the movement of the second rotor 5 is limited with the stopper 30, while rotating on the shaft 3.

In the example, as shown in FIGS. 1A and 1B, the second rotor 5 is capable of moving on the rotating shaft 3 in the axial (rotating shaft) direction while rotating on the shaft 3 response to variation of not only revolution torque but revolution speed of the rotor.

Herein, FIG. 1A shows a state where the maximum effective magnetic fluxes are required for example when the electric rotary machine works for the motor and when a required torque of the motor is large. In this case, the first rotor 4 and the second rotor 5 are located so as to come close to each other, same polarities of permanent magnets 4A and 5A are aligned with each other along the rotating shaft direction, and pole centers of same polarities of the respective permanent magnets 4A and 5A are matched with each other on the same line. The stopper 30 supports the second rotor 5 at the opposite side from the first rotor 4. A locating control for the second rotor 5 in the axial direction (rotating shaft direction) is performed by a control signal inputted to the actuator 31, and the location of the second rotor 5 in the axial direction is controlled at the predetermined position by using the helical spline 6 on the shaft 3 and the stopper 30.

FIG. 1 B shows another state (so-called mechanical field weakening) where the effective magnetic fluxes are reduced in comparison with the state as shown in FIG. 1A. This state is utilized in a state of for example a low torque and/or a high speed of the electric rotary machine. In this sate, the second rotor 5 is moved to any predetermined position by moving the same away from the first rotor 4 to one side (the opposite side from the first rotor 4) in the rotating shaft direction while rotating the same on the shaft 3. In this state, different polarities of the permanent magnets 4A and 5A are aligned with each other along the rotating shaft direction, and pole centers of same polarities of the respective permanent magnets 4A and 5A are offset with each other. According to the arrangement of FIG. 1B, an amount of effective magnetic fluxes used for the field becomes zero, and the counter electro motive force can be rendered zero. This characteristic of effective magnetic fluxes of zero can be utilized as protective function for the electric rotary machine. Herein, the effective magnetic fluxes are those that contribute to generation of rotating torque for the electric rotary machine. The effective magnetic fluxes are determined from the rotating torque for the electric rotary machine and the current flowing through the stator windings. Further, when the electric rotary machine is in the state shown in FIG. 1 B, the magnetic fluxes flow within the stator core 1 between the first rotor 4 as shown by reference numeral 8.

### Embodiment 1

Next, an embodiment of the present invention will be explained referring to FIG. 2. Incidentally, the embodiment of FIG. 2 has the same structure and effect as those of FIGS. 1A and 1B other than the following magnetoresistive layer 9. FIG. 2 shows an alignment of permanent magnets 4A and 5A of the first and second rotors 4 and 5 corresponding to that of FIG. 1B. As shown in FIG. 1B, the stator core 1 of the electric rotary machine is provided with a doughnut-shaped magnetoresistive layer 9 (of thickness: D2) in the path of the effective magnetic fluxes in the stator core 1, so that the stator core 1 is divided into two in the axis direction thereof by the doughnut-shaped magnetoresistive layer 9. Namely, the magnetoresistive layer 9 is interposed between the divided stator cores. Herein, in order to interrupt the magnetic flux flow 8, it is desirable that the magnetic resistance of the magnetoresistive layer 9 in the stator core 1 is higher than the magnetic resistance of the air gap 7 (of which distance between the rotor and the stator: D1). For example, when the magnetoresistive layer 9 is an air layer, it is desirable to set as D2>2×D1. According to such a structure with the magnetoresistive layer 9, when the revolution speed is in high speed, the electric rotary machine becomes so-called mechanical field weakening control (the rotor's state is varied from the state shown in FIG. 1A to the state shown in FIG. 1 B), and in this state, the magnetic flux flow 8 is interrupted by the magnetoresistive layer 9 on the way of the magnetic path in the stator core 1 in the rotating shaft direction. Accordingly, an iron loss (core loss) in the high speed revolution region of the magnetic flux variable type electric rotary machine can be greatly reduced.

Although the position of the magnetoresistive layer is not limited specifically, in order to shorten the length in the axial direction of the stator as much as possible, it is desirable that end faces of the first rotor 4 and the magnetoresistive layer 9 are arranged on a same plane.

Materials for the magnetoresistive layer 9 are those having a property of small magnetic permeability, namely, large magnetic resistance. For example, aluminum, copper, alumina, mica/glass, epoxy/glass, quartz, silicone, Teflon (Trade Mark from DUPON CO) and combinations thereof are enumerated for the materials. Further, the layer can be formed by spacing the cores, in other words, by an air layer.

Further, in the present embodiment wherein the rotor of the electric rotary machine is divided into two, although the provision of a single magnetoresistive layer 9 in the stator core 1 has been explained, it is needless to say that more than one layers with a gap can be provided in the stator core.

### Embodiment 2

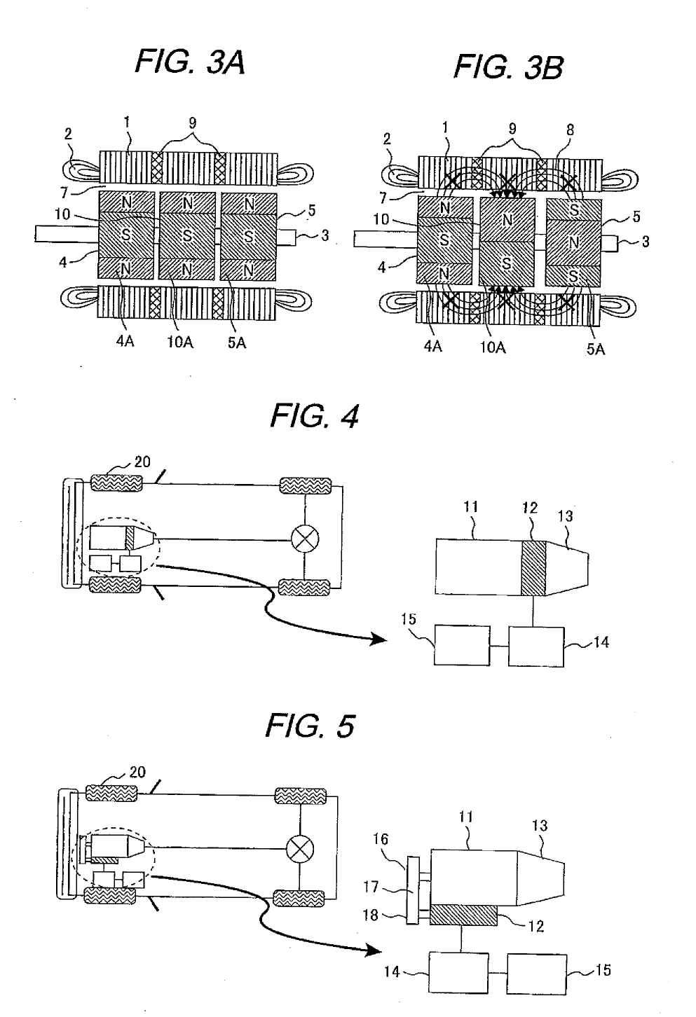

Another embodiment of an electric rotary machine according to the present invention will be explained based on FIG. 3. Herein below, the same parts as in the previous embodiment are denoted with the same reference numerals and the explanation thereof is omitted, and only the parts different from the previous ones will be explained.

As shown in FIG. 3, the present embodiment has a structure in which a third rotor 10 is provided between the first rotor 4 and the second rotor 5 and two magnetoresistive layers 9 are provided in the stator core 1 of an electric rotary machine. Namely, the rotor is divided into three in the rotor shaft direction, the stator core is also divided into three in the same direction as the rotor, and the doughnut-shaped magnetoresistive layers are interposed respective between the divided stator cores. Namely, the machine has a structure in which one magnetoresistive layer 9 is provided at a portion in the stator core 1 corresponding to the position between the first rotor 4 and the third rotor 10 (at a position where the magnetic flux flow is interrupted between the first rotor 4 and the third rotor 10) and another magnetoresistive layer 9 is provided at a portion in the stator core corresponding to the position between the third rotor 10 and the second rotor 5 (at a position where the magnetic flux flow is interrupted between the third rotor 10 and the second rotor 5). In the electric rotary machine with this structure, as shown in FIG. 3, the second rotor 5 and the third rotor 10 are movable in the rotor shaft direction by engagement of the inner female thread thereof and the helical spline 6 on the rotor shaft with the stopper and actuator (not shown) just as with FIGS. 1A, 1B and FIGS. 2A, (2b) in response to variation of torque and revolution number. Namely, in the present embodiment, the positions of the second and third rotors are controlled to any state from the state as shown in FIG. 3 A to the state as shown in FIG. 3 B.

Herein, FIG. 3 A shows a state when the maximum effective magnetic fluxes are required, wherein the first rotor 4, the third rotor 10 and the second rotor 5 are located so as to come close to each other, same polarities of permanent magnets 4A, 10A and 5A are aligned with each other along the rotating shaft direction on the same line, and pole centers of the same polarities of the respective permanent magnets 4A, 10A and 5A are matched with each other on the same line.

In the above operation where the positions of the second and third rotors are controlled from the state of FIG. 3 A to the state of FIG. 3 B in a direction opposite to the first rotor 4, at first, the third rotor 10 and the second rotor 5 move together in a direction opposite to the first rotor 4 in a direction opposite to the first rotor 4, and the third rotor 10 is stopped by a first stopper (not shown) and its actuator (not shown) at a first position where the respective pole centers (centers of N pole and S pole) of the permanent magnets 10A of the third rotor 10 are offset by a half mechanical angle from the pole centers of the permanent magnets 4A of the first rotor (a condition is assumed where the attraction force and repulsion force between the permanent magnets of the first rotor and the third rotor balance).

For example, when the rotor is constituted by eight pole permanent magnets, the mechanical angle for one magnet is 45°, and the pole center positions at 22.5° from an end of the magnet. The second rotor 5 moves continuously in the same direction until the rotor 5 reaches a second stopper (not shown) and its actuator (not shown), namely a second position which is the same as that of FIG. 2). As shown in FIG. 3 B, centers of the respective magnetic poles of the second rotor 5 match to the centers of the respective magnetic poles of opposite polarity of the first rotor 4.

In the present embodiment, as shown in FIG. 3, in the stator core 1 of the electric rotary machine, two magnetoresistive layers 9 (of thickness: D2) are provided respective between the divided stator core 1 at the positions corresponding to the gaps between the divided rotors. Herein, in order to interrupt the magnetic flux flow 8, it is desirable that the magnetic resistance of the magnetoresistive layer 9 in the stator core 1 is higher than the magnetic resistance of the air gap 7 (of which distance between the rotor and the stator: D1). For example, when the magnetoresistive layer 9 is an air layer, it is desirable to set as D2>2×D1. With this structure, when the revolution speed is in high speed, the electric rotary machine becomes so-called mechanical field-weakening control (the rotor's state is varied from the state shown in FIG. 3 A to the state shown in FIG. 3 B), and in this state, the magnetic flux flow 8 is interrupted by the magnetoresistive layers 9 on the way of the magnetic path in the stator core 1 in the rotating shaft direction. Accordingly, an iron loss (core loss) in the high speed revolution region of the magnetic flux variable type electric rotary machine can be greatly reduced.

The structure of three divided rotors, as shown in FIGS. 3 A and 3 B, it is preferable to equally divide the rotor into three. Namely, ratio of the respective lengths in the rotating shaft direction of the first rotor, the second rotor and the third rotor of the trisectioned rotor gives 1:1:1. By equally dividing in this manner, the magnetic balance can be easily taken.

Further, in the present embodiment wherein the rotor of the electric rotary machine is divided into three, although the provision of two magnetoresistive layers 9 in the stator core 1 has been explained, it is needless to say that more than tow layers with predetermined interval can be provided in the stator core.

### Embodiment 3

In the present embodiment, an example will be explained in which the electric rotary machine as proposed in the present invention is applied to a driving system for a hybrid car.

FIG. 4 shows an arrangement of a driving system for a hybrid car. The driving system for the hybrid car comprises wheels 20, an internal combustion engine (hereafter its called as engine) 11 for driving the wheels, a transmission 13 for controlling velocity of the vehicle, and a permanent magnet type synchronous electric rotary machine (hereafter its called as electric rotary machine 12) and the transmission 13. The electric rotary machine 12 is one having the characteristics as explained in connection with the embodiment 1 or embodiment 2.

The electric rotary machine 12 is mechanically coupled between the engine 11 and the transmission 13 as described above.

For the coupling between the engine 11 and the electric rotary machine 12, methods are employed such as a method of directly connecting an illustration omitted output shaft of the engine 11 with the rotating shaft of the electric rotary machine 12 and a method of connecting both via a speed changer constituted by such as a planetary gear speed reduction mechanism.

Since the electric rotary machine 12 operates as a motor or a generator changeably, the electric rotary machine 12 is connected electrically to a battery 15 of electric power storage device for performing charging and discharging electric power via an inverter 14 of power conversion device. When the electric rotary machine 12 is used as a motor, after converting DC power outputted from the battery 15 into AC power by the inverter 14, the AC power is supplied to the electric rotary machine 12. Thereby, the electric rotary machine 12 is driven. The driving force of the electric rotary machine 12 is used for starting the engine 11 or for assisting the same. When the electric rotary machine 12 is used as a generator, after converting AC power generated by the electric rotary machine 12 into DC power by the inverter 14 (converter function), the DC power is supplied to the battery 15. Thereby, the converted DC power is charged in the battery 15. Namely, the inverter 14 is connected between the battery 15 and the electric rotary machine 12, and performs power conversion.

With respect to the conventional permanent magnet type synchronous electric rotary machine, since counter electromotive power due to magnets increases depending on an increase of the revolution number (revolution speed), it was difficult to drive the same in a high speed revolution region because of limitations due to a battery and an inverter. As a method of driving an electric rotary machine in a high speed revolution region, there is a field weakening control by making use of an electrical current for equivalently weakening the field magnetic fluxes by permanent magnets, however, since an electrical current not contributing to the torque generation has to be flown, which leads to a reduction of efficiency. On the other hand, since the magnetic flux variable type electric rotary machine according to the present invention is used for the above electric rotary machine, an optimum field use effective magnetic fluxes can be generated mechanically in response to revolution number (revolution speed) and torque. Accordingly, the limitations by a battery and an inverter due to the counter electromotive power can be reduced, and further no current that contributes torque generation is flown, the efficiency of the machine can be enhanced. Still further, since the magnetic flux flow in the rotating shaft direction caused during a high speed revolution is interrupted, an iron loss of the electric rotary machine during a high speed revolution (mechanical magnetic field weakening control) is greatly reduced. As a result, an efficiency of the electric rotary machine can be enhanced.

According to the present embodiment, when the electric rotary machine of the present invention is applied for the hybrid car, since a withstand voltage of the inverter can be reduced, the capacity of the inverter can be reduced. As a result, reduction of the cost and volume of the inverter can be achieved. Further, since the magnetic flux variable type electric rotary machine of the present invention can be operated over a broad revolution speed range with a high efficiency, reduction of stages of the speed change gear or omission of the speed change gear is possibly realized. Accordingly, the size reduction of the total driving system can also be achieved.

### Embodiment 4

In the present embodiment, another example will be explained in which the electric rotary machine as proposed in the present invention is applied to a driving device for a hybrid car.

FIG. 5 shows an arrangement of a driving system for a car on which the electric rotary machine of the embodiment 1 or the embodiment 2 is mounted. In the driving system of the present embodiment, a crank pulley 16 for the engine (internal combustion engine) 11 and a pulley 18 connected to the shaft of the electric rotary machine 12 are coupled by a metal belt 17. Accordingly, although the engine 11 and the electric rotary machine 12 are arranged in series in embodiment 3, the engine 11 and the electric rotary machine 12 are arranged in parallel in the present embodiment 4.

Further, in the driving system for a car of the present embodiment, the electric rotary machine 12 can be used in any manner such as solely as a motor, solely as a generator or as a motor and generator. According to the present embodiment, a speed change mechanism having any speed ratio can be constituted between the engine 11 and the electric rotary machine 12 with the crank pulley 16, the metal belt 17 and the pulley 18. For example, when setting the radius ratio between the crank pulley 16 and the pulley 18 as 2:1, the electric rotary machine 12 can be rotated at a speed of two times higher than that of the engine 11, thereby, the torque of the electric rotary machine 12 at the start time of the engine 11 can be reduced to ½ of the torque necessary at the start time of the engine 11. Accordingly, the size of the electric rotary machine 12 can be reduced. Still further, since the magnetic flux flow in the rotating shaft direction caused during a high speed revolution is interrupted, an iron loss of the electric rotary machine during a high speed revolution (mechanical field weakening control) is greatly reduced. As a result, an efficiency of the electric rotary machine can be enhanced.

Further, the followings are examples of embodiments for a car in which the electric rotary machine of the embodiment 1 or the embodiment 2 is used

A car comprises an internal combustion engine for driving wheels, a battery for charging and discharging electric power, a motor/generator that is mechanically coupled to the crank shaft of the internal combustion engine, the motor/generator is driven by electric power fed from the battery to drive the internal combustion engine, as well as is driven by driving force from the internal combustion engine to generate electric power and feed the generated electric power to the battery, an electric power conversion device that controls electric power fed to the motor/generator and electric power fed from the motor/generator and a control device for controlling the electric power conversion device, wherein the motor/generator is constituted by the electric rotary machine of the embodiment 1, the embodiment 2, the embodiment 3 or the embodiment 4. The above car is an ordinary car that drives the wheels by the internal combustion engine or a hybrid car that drives the wheels by the internal combustion engine and by the motor/generator.

Further, a car comprises an internal combustion engine for driving wheels, a battery for charging and discharging electric power, a motor/generator that is driven by electric power fed from the battery to drive the wheels as well as receives driving force from the wheels to generate electric power and feed the generated electric power to the battery, an electric power conversion device that controls electric power fed to the motor/generator and electric power fed from the motor/generator and a control device for controlling the electric power converting device, wherein the motor/generator is constituted by the electric rotary machine of the embodiment 1 or the embodiment 2. The above car is a hybrid car that drives the wheels by the internal combustion engine and by the motor/generator.

Further, a car comprises a battery for charging and discharging electric power, a motor/generator that is driven by electric power fed from the battery to drive the wheels, as well as receives driving force from the wheels to generate electric power, and feeds the generated electric power to the battery, an electric power conversion device that controls electric power fed to the motor/generator and controls electric power fed from the motor/generator and a control device for controlling the electric power conversion device, wherein the motor/generator is constituted by the electric rotary machine of the embodiment 1 or the embodiment 2. The above car is an electric car that drives the wheels by the motor/generator.

### Embodiment 5

In the present embodiment, an example will be explained in which the electric rotary machine as proposed in the present invention is applied to a motor for a washing machine.

In a conventional art washing machine, when transferring torque from a motor by means of a belt and gear via a pulley, there is a problem of large noises caused by such as sliding sound and impacting sound between the belt and the gear. Further, in a direct drive type washing machine in which the torque from a motor is directly transferred to such as a rotated member and a dewatering vessel, it is limited to broaden a high speed operation region with the control technology of electrically weakening magnetic field because of heating and efficiency reduction due to the current for weakening the magnetic field. Since the above direct drive type washing machine has no speed reduction mechanism, the size of the motor is enlarged which is required to cover a broad speed range from a washing and rinsing process requiring a low speed and high torque to a dewatering process requiring a high speed and large output.

When the magnetic flux variable type electric rotary machine of the present invention is used for the above motor, during the washing and rinsing process, if the pole centers of same polarity of the divided rotors in the motor are matched with each other, the amount of effective magnetic fluxes by the permanent magnets facing the stator windings is increased, and a high torque characteristic can be obtained. On the other hand, when the motor is operating in a high speed revolution region such as during dewatering process, if one of the divided rotors that is permitted relative rotation with respect to the other is rotated in the direction of offsetting the pole center of the same polarity, the amount of effective magnetic fluxes by the permanent magnets facing the stator windings is decreased, in other words, the mechanical magnetic field weakening effect is given, and a constant output characteristic is obtained in a high speed revolution region. Still further, since the magnetic flux flow in the rotating shaft direction caused during a high speed revolution is interrupted, an iron loss of the electric rotary machine during a high speed revolution (mechanical magnetic field weakening control) is greatly reduced. As a result, an efficiency of the electric rotary machine can be enhanced.

### Embodiment 6

In the present embodiment, an example will be explained in which the electric rotary machine as proposed in the present invention is applied to a generator for a wind power generating system.

In a conventional generator for a wind power generating system, although a high torque is obtained in a low speed region thereof, however, since the variable range of the revolution number is narrow, an operation thereof in a high speed revolution region was difficult. Therefore, it is conceivable to broaden the high speed operation region by means of the control technology of electrically weakening magnetic field. Further, the generator for a wind power generating system is provided with such as a gear mechanism and a pitch motor for ensuring a predetermined output in a broad speed range to thereby meet a variety of wind speed conditions. A generator for a wind power generating system is also proposed which is driven by switching the respective phase windings of the generator between low speed use windings and high speed use windings in response to the rotating speed of the main shaft by making use of windings switching device. However, it is limited to broaden a high speed operation region with the control technology of electrically weakening magnetic field because of heating and efficiency reduction due to the current for weakening the magnetic field. When the windings switching device is used that switches the respective phase windings in response to the rotating speed of the main shaft, there arise such problems that number of lead wires from the generator main body increases and further, that the windings switching control device and its structure are complicated.

An embodiment, which makes use of the electric rotary machine constituted according to the embodiment 1 or the embodiment 2 as a generator for a wind power generating system, performs an operation with a high efficiency in a broad range of wind power, if the divided rotors are operated under the following condition. In a low speed rotation region where the wind power is weak, the pole centers of same polarity of the divided rotors are matched with each other so that the amount of effective magnetic fluxes by the permanent magnets facing the stator windings is increased, and a high output characteristic can be obtained. On the other hand, in a high speed rotation region where the wind power is strong, one of the divided rotors that is permitted relative rotation with respect to the other is located in the direction of offsetting the pole center of the same polarity so that the amount of effective magnetic fluxes by the permanent magnets facing the stator windings is decreased, in other words, the mechanical field weakening effect is given, and that a constant output characteristic is obtained in a high revolution region. Still further, since the magnetic flux flow in the rotating shaft direction caused during a high speed revolution is interrupted, an iron loss of the electric rotary machine during a high speed revolution (mechanical field weakening control) is greatly reduced. As a result, an efficiency of the electric rotary machine can be enhanced.

According to the present embodiment, an advantage that the amount of field use effective magnetic fluxes can be varied mechanically. In particular, the mechanical field weakening of the main shaft generator in the wind power generating system can be performed easily, which is a great advantage for a broad range variable speed control. Since the weight of the generator is reduced, because of the simplified structure of the generator, an advantage that the structure of a tower therefor is simplified is obtained.

### Embodiment 7

In the present embodiment, an example will be explained in which the electric rotary machine as proposed in the present invention is applied to a motor/generator for a transportation vehicle.

A permanent magnet type synchronous motor has a high efficiency in comparison with an induction motor, which is advantageous for reducing the size and weight thereof. Further, because of the high efficiency, reduction of the amount of power consumption and of the amount of CO₂ emission can also be expected. Since a motor used for driving a transportation vehicle is strongly required to be small size and light weight, the permanent magnet type synchronous motor is a convincing candidate. Further, the light weighting is required not only for the motor but also for the total main circuit including the inverter. In view of protecting the main conversion device, the counter induced voltage by the permanent magnets has to be designed so that at least the peak value thereof does not exceed beyond a set value for an over voltage protecting operation with respective to DC intermediate circuit voltage. However, if the motor is designed as such, a necessary capacity of the inverter is caused increased.

When the magnetic flux variable type electric rotary machine of the present invention is used for the above motor, during a low speed and a high torque operation, if the pole centers of same polarity of the divided rotors in the motor are matched with each other, the amount of effective magnetic fluxes by the permanent magnets facing the stator windings is increased, and a high torque characteristic can be obtained. On the other hand, when the motor is operating in a high speed revolution region, if one of the divided rotors that is permitted relative rotation with respect to the other is located in the direction of offsetting the pole center of the same polarity, the amount of effective magnetic fluxes by the permanent magnets facing the stator windings is decreased, in other words, the mechanical magnetic field weakening effect is given, and a constant output characteristic is obtained in a high revolution region. Still further, since the magnetic flux flow in the rotating shaft direction caused during a high speed revolution is interrupted, an iron loss of the electric rotary machine during a high speed revolution (mechanical magnetic field weakening control) is greatly reduced. As a result, an efficiency of the electric rotary machine can be enhanced.

According to the present embodiment, an advantage is obtained that the amount of field use effective magnetic fluxes can be varied mechanically. Further, the mechanical magnetic field weakening of the generator for a transportation vehicle can be performed easily, which is a great advantage for a broad range variable speed control. Still further, through varying the effective magnetic fluxes mechanically, the counter induced voltage can be suppressed. As a result, the capacity of the inverter can be reduced. Accordingly, such as cost reduction of the inverter and size reduction of the total driving device can also be achieved.

The embodiments as has been disclosed hitherto are exemplary ones in all sense and should not be construed as limitative ones. The scope of the present invention is not the ones as explained above but the one defined in the claims, and is intended to cover all of the modifications within the equivalent of the claimed invention.

What is claimed is:

1. An electric rotary machine comprising:
a stator having a stator core and windings,
a rotor that is incorporated rotatablly inside the stator keeping an air gap between the rotor and the stator, the rotor being divided into at least two of a first rotor and a second rotor in a direction of a rotating shaft thereof, and each of the first and second rotors having field magnets with different polarities disposed alternatively in a rotating direction of the rotor, and
a magnetic flux control mechanism that controls effective magnetic fluxes by varying positions of the field magnets of the second rotor relatively with respect to that of the first rotor in at least the rotating direction of the rotor,
wherein the stator core is provided with a magnetoresistive layer that is interposed in the path of the effective magnetic fluxes in the stator core.

2. The electric rotary machine according to claim 1,
wherein the stator core is divided into at least two in the direction of the rotating shaft, and
wherein the magnetoresistive layer has a doughnut shape, and the magnetoresistive layer is interposed between the divided stator cores.

3. The electric rotary machine according to claim 1,
wherein the magnetoresistive layer is constituted by at least one of aluminum, copper, alumina, mica/glass, epoxy/glass, quartz, silicone and Teflon (Trade Mark from DUPON CO).

4. The electric rotary machine according to claim 1,
wherein the magnetoresistive layer is an air layer.

5. A car comprising:
wheels,
an internal combustion engine for driving the wheels,
a transmission for controlling the velocity of the car,
an electric rotary machine that is used for motor/generator and mechanically coupled between the internal combustion engine and the transmission,
a power storage device that charges electrical power from the electric rotary machine and discharges the electrical power to the electric rotary machine changeably, and
an electric power conversion device that is connected between the power storage device and the electric rotary machine and performs electric power conversion,
wherein the electric rotary machine is constituted by the same according to claim 1.

6. A car comprising:
wheels,
an internal combustion engine for driving the wheels,
a transmission for controlling the velocity of the car,
an electric rotary machine that is used for motor/generator and mechanically coupled between the internal combustion engine and the transmission,
a metal belt coupling a crank pulley of the internal combustion engine and a pulley connected to a shaft of the electric rotary machine,
a power storage device that charges electrical power from the electric rotary machine and discharges the electrical power to the electric rotary machine changeably, and
an electric power conversion device that is connected between the battery and the electric rotary machine and performs electric power conversion, and,
wherein the electric rotary machine is constituted by the same according to claim 1.
